(19) United States
(12) Patent Application Publication
(10) Pub. No.: US 2004/0216354 A1
(43) Pub. Date: Nov. 4, 2004

(54) Pocket fishing net

(76) Inventor: Robert B. Soest, High Ridge, MO (US)

Correspondence Address: Polster, Lieder, Woodruff & Lucchesi, L.C., Suite 230, 763 South New Ballas Road, St. Louis, MO, 63141-8750, US

(21) Appl. No.: 10/682,007

(22) Filed: Oct. 9, 2003

Related U.S. Application Data
(60) Provisional application No. 60/417,339, filed on Oct. 9, 2002.

(51) Int. Cl. A01K 71/00

(52) U.S. Cl. 43/7

(57) ABSTRACT

An improved fishing net (10) has a handle (12). One end of the handle is looped and provides a mouth for fish net (14). The net has two sections (14A, 14B). A first net section (14A) has its mouth end attached to the net handle. The section then tapers toward its lower, also open, end which is encircled by an elastic band (16). The second net section (14B) comprises a pocket whose upper, mouth end is attached to the elastic band. This lower, bottom end of the pocket is closed so fish landed in the net cannot escape from it. The pocket is elongated and of a relatively small diameter so a fish caught in the lower end of the net cannot move about too much. This allows a fisherman to readily grasp the fish by encircling his hand about the pocket and gently squeezing the fish.

### CROSS REFERENCE TO RELATED APPLICATIONS

Provisional patent application 60/417,339, filed Oct. 9, 2002.

### STATEMENT REGARDING FEDERALLY SPONSORED RESEARCH OR DEVELOPMENT

N/A

### BACKGROUND OF THE INVENTION

This invention relates to fishing nets and more particularly, to an improved fishing net having an upper net section and a lower net section. The lower net section forms a pocket in which fish caught in the net are captured so to be readily grasped by an angler.

With the increasing popularity of “catch and release” fishing as a conservation goal, the sport of fishing has an added, new dimension in which it is important that when a fish is caught, it be treated in the least harmful manner before being released. In this regard, it is now desirable to be able to observe the fish once it is caught so the fish can be measured, photographed, or tagged, while in captivity; and then placed back into the water. One way of keeping fish that are caught is to place them in a fishing net. If the net is kept in the water, the fish will not suffocate. However, conventional nets have certain disadvantages.

One is that it is often difficult to control the fish so that it can be readily picked up for measuring, photographing, or tagging. Most fishing nets are so wide at their mouth that the only way a fisherman can seize the fish is to reach his hand into the net and lift the fish out. Because the fish is slippery and wriggling, the fisherman cannot always control the fish unless he grasps it tightly which can injure the fish.

The present invention overcomes these disadvantages by not only making it easy for the fisherman to net a fish, but to also easily control it once it is caught and readily release it.

### BRIEF SUMMARY OF THE INVENTION

The present invention comprises an improved fishing net. The net has a handle one end of which is grasped by the fisherman. The other end of the handle forms a loop which defines the mouth for a fish net attached to the handle. The net comprises two sections. A first or upper section has its mouth end attached to the looped end of the handle. This section then tapers toward its lower, also open, end which is encircled by an elastic band. A second section of net has an upper, mouth end attached to the elastic band. This second section of the net comprises a close ended pocket so fish landed in the net cannot escape from the net. The pocket formed by this second net section is an elongated, relatively narrow diameter pocket. A fish caught in the pocket cannot move about too much in it. This enables a fisherman to readily grasp and control the fish by encircling his hand about the pocket and gently squeezing the fish.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a top plan view of the net of the present invention; and,

FIG. 2 is an elevation view of the net.

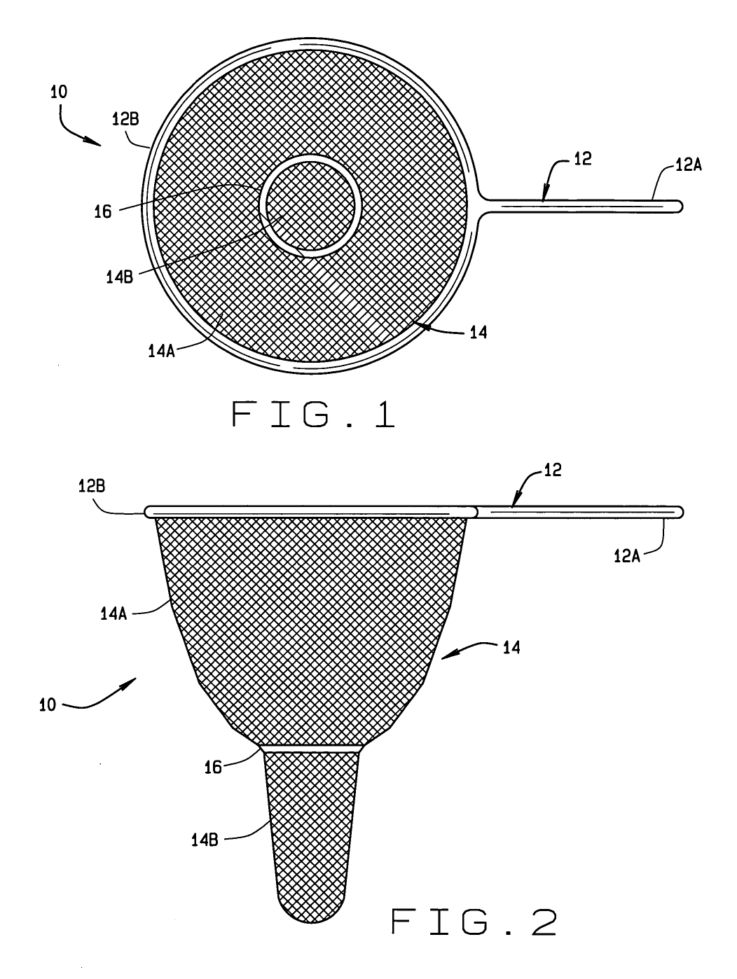

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

Referring to the drawings, an improved fishing net of the present invention is indicated generally 10. The fishing net has a handle 12 one end 12A of which is grasped by the fisherman to maneuver the net when a fish is caught on the end of a line. The other end 12B of the handle is formed into a loop. The loop defines a mouth for a fish net 14 which is attached to handle 12.

Net 14 comprises two sections 14A, 14B. A first or upper section 14A of the net has its mouth end attached to looped end 12B of handle 12. The net has its greatest diameter and circumference at the mouth of the net. From the mouth of the net, section 14A tapers downwardly toward its lower, open end. The taper or reduction in net diameter is gradual so the net has sufficient volume to hold a fish once the fish is placed in the net.

At the lower end of net section 14A, an elastic band 16 encircles the net. As such, the band defines a mouth for a second net section 14B the upper end of which is also attached to the elastic band.

The second section of net 14 forms a pocket whose lower end is closed and whose upper end is open. Since the pocket is closed at its lower reaches, a fish landed in the net cannot escape through the bottom of the net. Importantly, the second, pocket section of the net comprises an elongated, relatively narrow diameter fish net. The length of net section 14B is greater than the diameter of the pocket at the mouth of the pocket.

A fish caught in fishing net 10 will tend to fall into pocket 14B when handle 12 is held in a substantially horizontal position so the net is upright. Because the length of the pocket is wider than the diameter of the pocket, fish will tend to fit lengthwise into this lower end of the net. Further, because of the relatively narrow diameter of the pocket, the fish will be constrained in the net and not be able to move about too much in the bottom of the net. This allows a fisherman to readily grasp and control the fish simply by encircling his hand around the outside of the pocket and gently squeeze the fish. When the fish is to be returned to the water, or placed in a catch box, the fisherman simply grasps the bottom of pocket 14B with one hand and inverts the fishing net with his other hand. This will cause the fish to drop straight out of the net, back into the water.

The net can be of any convenient material including a rope or twine, nylon, or another plastic filament material. It will further be understood that the net can be formed of a continuous web of material with elastic band 16 encircling the net at the appropriate location. Or, the net can be in two sections 14a, 14b separated by band 16.

In view of the above, it will be seen that the several objects and advantages of the present invention have been achieved and other advantageous results have been obtained.

Having thus described the invention, what is claimed and desired to be secured by Letters Patent is:

1. A fishing net for the capture and live release of a fish comprising:
a handle grasped by a user of the net; and,
a net attached to the handle and having two sections, a first and upper section a mouth end of which is attached to the handle for scooping a fish into the net, and a second and lower section in which the fish is retained after capture and until release, the lower end of the upper section of the net being open for the fish to fall through the upper section of the net into the second section thereof, the upper end of the lower section of the net being open for the fish to fall into the lower section of the net, and the lower end of the second section of the net being closed so to retain the fish in the net after its capture.

2. The fishing net of claim 1 in which the handle has one end which is grasped by a fisherman to maneuver the net when a fish is caught on the end of a line, the other end of the handle comprising a loop about which the upper end of the first section of the net attaches, the loop defining a mouth of the net.

3. The fishing net of claim 2 in which the largest diameter and greatest circumference of the net is at the open, upper end of the first section of the net.

4. The fishing net of claim 3 in which the first section of the net tapers in diameter from its upper end to its lower end, the taper in diameter being a gradual taper so the upper section of the net has sufficient volume to hold a fish once the fish is caught in the net.

5. The fishing net of claim 4 further including a band encircling the net at the juncture between the first and second sections of the net, the lower end of the upper section of the net and the upper end of the lower section of the net each being connected to the band, and the band defining a mouth to the second section of the net.

6. The fishing net of claim 5 in which the band is an elastic band.

7. The fishing net of claim 5 in which the second section of the net forms a pocket whose lower end is closed so a fish landed in the net cannot escape through the bottom of the net.

8. The fishing net of claim 7 in which the pocket comprises an elongated, narrow diameter fish net whose length is greater than its diameter at the mouth of the second section of the net.

9. The fishing net of claim 7 in which the length of the pocket is wider than the diameter of the pocket so a fish caught in the net will fit lengthwise into the second section of the net, be constrained therein and not able to move about in the bottom of the net, thereby allowing a fisherman to readily grasp and control the fish by encircling his hand around the outside of the second section of the net and squeezing the fish.

10. A fishing net for the capture and live release of a fish comprising:
a handle having one end which is grasped by a fisherman to maneuver the net when a fish is caught on the end of a line, the other end of the handle comprising a loop; and, a net attached to the handle and a first section with a mouth end which attaches to the loop end of the handle for scooping a fish into the net, and a second section in which the fish is retained after capture and until release, the lower end of the first section being an open end for the fish to fall through the first section of the net into the second section thereof, the second section of the net comprising an elongated, narrow diameter pocket whose length is greater than its diameter at a mouth of the second section of the net.

11. The fishing net of claim 10 further including a band encircling the net at the juncture between the first and second sections thereof, the lower end of the first section of the net and the upper end of the second section of the net each being connected to the band with the band defining a mouth to the second section of the net

12. The fishing net of claim 11 in which the length of the pocket is wider than its diameter so a fish caught in the net will fit lengthwise into the second section of the net, and be constrained therein and not able to move about in the bottom of the net so to allow a fisherman to readily grasp and control the fish by encircling his hand around the outside of the second section of the net and squeezing the fish

13. The fishing net of claim 12 in which the first section of the net tapers in diameter from its upper end to its lower end, the taper in diameter being a gradual taper so the upper section of the net has sufficient volume to hold a fish once the fish is caught in the net.

14. The fishing net of claim 11 in which the band is an elastic band.
